(19) United States
(12) Patent Application Publication
(10) Pub. No.: US 2005/0097003 A1
(43) Pub. Date: May 5, 2005

(54) Retrieving and formatting information

(76) Inventor: Jon Jason Linker, Morro Bay, CA (US)

Correspondence Address: SINSHEIMER, SCHIEBELHUT, BAGGETT, 1010 PEACH STREET, SAN LUIS OBISPO, CA, 93401, US

(21) Appl. No.: 10/959,379

(22) Filed: Oct. 5, 2004

Related U.S. Application Data
(60) Provisional application No. 60/509,208, filed on Oct. 6, 2003.

(51) Int. Cl. G06F 17/60

(52) U.S. Cl. 705/26

(57) ABSTRACT

According to a computer-implemented approach for retrieving item information by customers, customers specify item selection criteria(s) in order to obtain information about each individual item(s). According to the approach, a customer provides item selection criteria's to a provider and the provider sorts and displays the item information to the customer over a medium such as the Internet.

### CROSS REFERENCE TO RELATED APPLICATION

This application claims the benefit of U.S. Provisional Application No. 60/509,208, filed Oct. 6, 2003.

### FIELD OF INVENTION

The present application relates to a method for retrieving item information and more specifically, to a computer-implemented approach for selecting and retrieving item information for customers.

### BACKGROUND OF THE INVENTION

Conventional store models involve the customers having to physically find a store that carries the item they desire. Moreover to price compare an item, a customer must find multiple stores that carry that item in order to make the optimal purchasing decision.

There is further need for an approach to locating items for customers that ensures the correct selection of the item descriptors needed for the item selection criteria across a medium.

Conventional store models require a customer to call or physically go to the store to see if the item they desire is in stock.

Customers are often unaware of all the locations within close proximity that carry the item they desire.

Once in a store customers would like to know where items are located within the store to make there shopping experience as time efficient as possible.

Conventional store models require the customer to utilize their internal registry system in order to make desired item lists available to others.

Currently there is no way to price compare a grocery list against multiple store location in an efficient manner.

Conventional search engines often return results in the hundreds and even thousands of records when performing a search on a single item.

Price comparison search engines often perform price comparison on web merchants only not traditional brick and motor type stores.

Given the current demand for a unified solution and the limitations of current conventional store models a new approach is needed to assist customers in locating items by best price and/or best location.

### SUMMARY OF THE INVENTION

A method and apparatus of the present application in one aspect allows customers to retrieve information on one or many items sorted by best price and/or best location. This embodiment uses a unified solution that includes but is not limited to UPC codes, RFID tags, MPN, keywords, category, ad-hoc expression, hand (barcode) scanners, cell phones, Global Positioning Systems (GPS), personal data assistants (PDA), computers and the Internet.

In one embodiment a method for providing store branded item information comprising identifying store branded items equivalent to brand name items, cross-referencing said store branded items to brand name items, storing information pertaining to store branded items and brand name items in a database, providing selection criteria to said database, wherein said database sorts said store branded item information, and displaying said store branded item information to a user via a communications means is disclosed.

### BRIEF DESCRIPTION OF THE DRAWINGS

Embodiments of the application are illustrated by way of example, and not by way of limitation, in the figures of the accompanying drawings and in which like reference numerals refer to similar elements and in which:

FIG. 1 is a diagram depicting an approach for retrieving item information including but not limited to location, price, and stock status for customers according to an embodiment.

FIG. 2 is a diagram depicting an approach for customer and provider to exchange information over the Internet according to an embodiment.

FIG. 3 is a flow diagram depicting an approach for selecting a unique item descriptor using a category search engine.

FIG. 4 is a flow diagram depicting an embodiment of how a customer would enter a UPC code via web enabled cell phone.

FIG. 5 is a flow diagram depicting an approach a customer would use to create item selection criteria according to an embodiment.

FIG. 6 is a flow diagram depicting an embodiment of how a customer would create an item selection criteria using devices with different capabilities.

FIG. 7 is a flow diagram depicting an embodiment of how a provider would allow the customer to select a unique item descriptor starting from an ad-hoc, non-unique search expression.

FIG. 8 is a screen shot showing an embodiment of a category search engine opening web page.

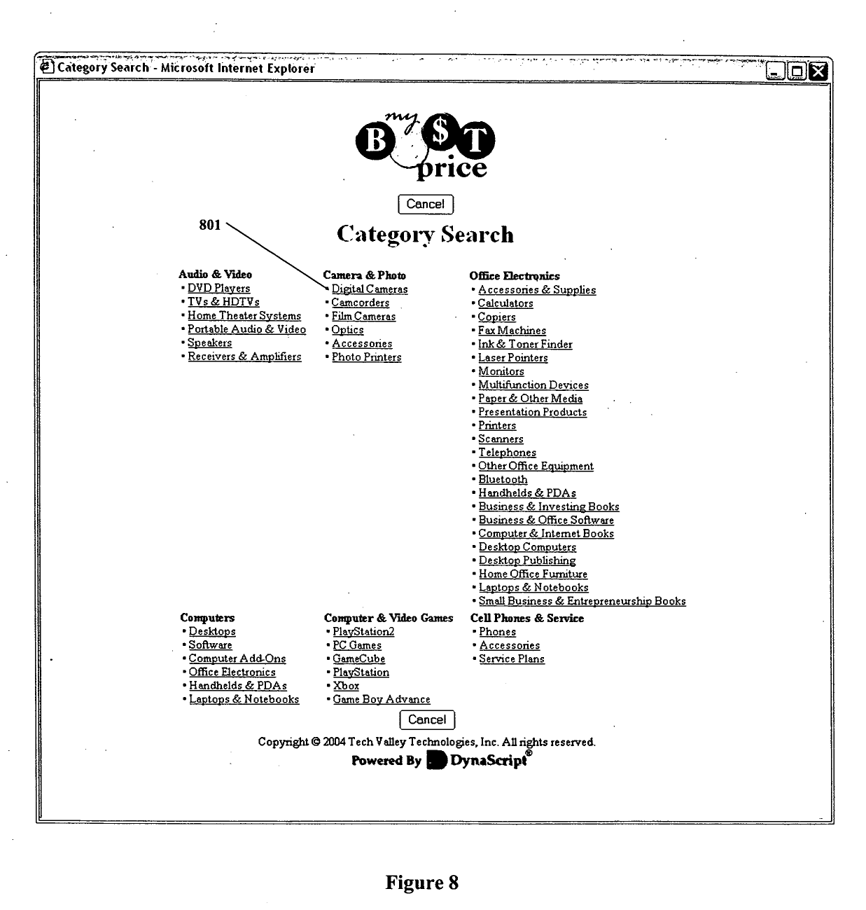

FIG. 9 is a screen shot showing an embodiment of a category search engine sub category web page.

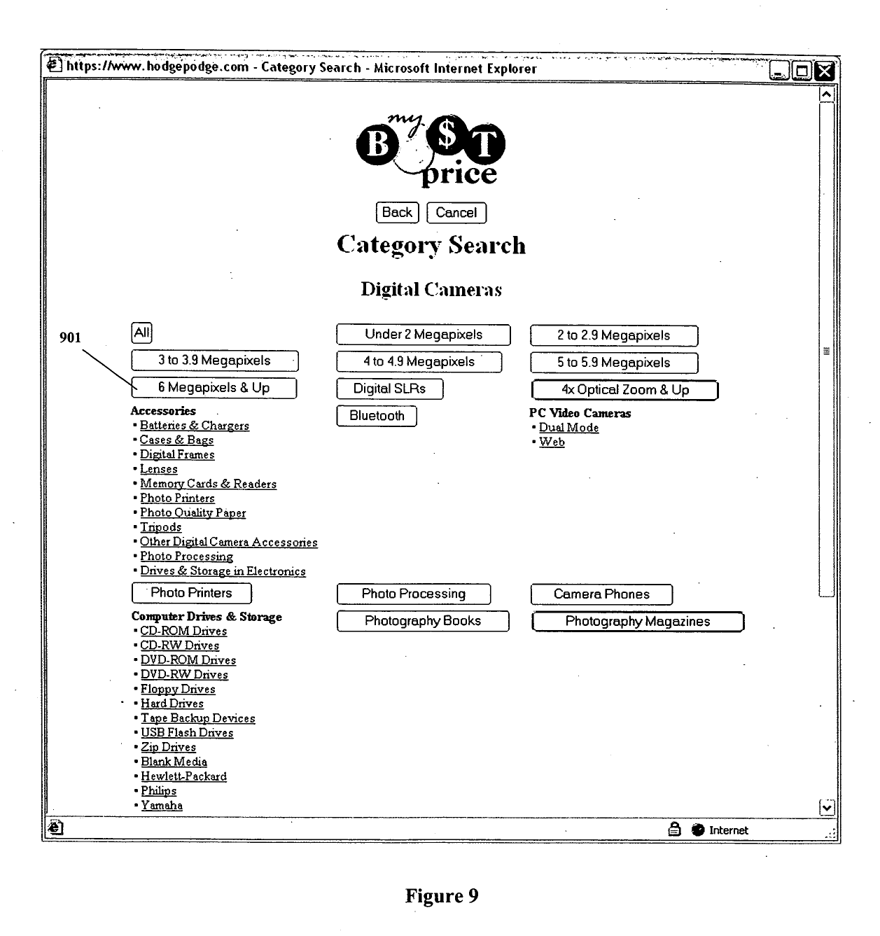

FIG. 10 is a screen shot showing an embodiment of an item listing for a sub category web page.

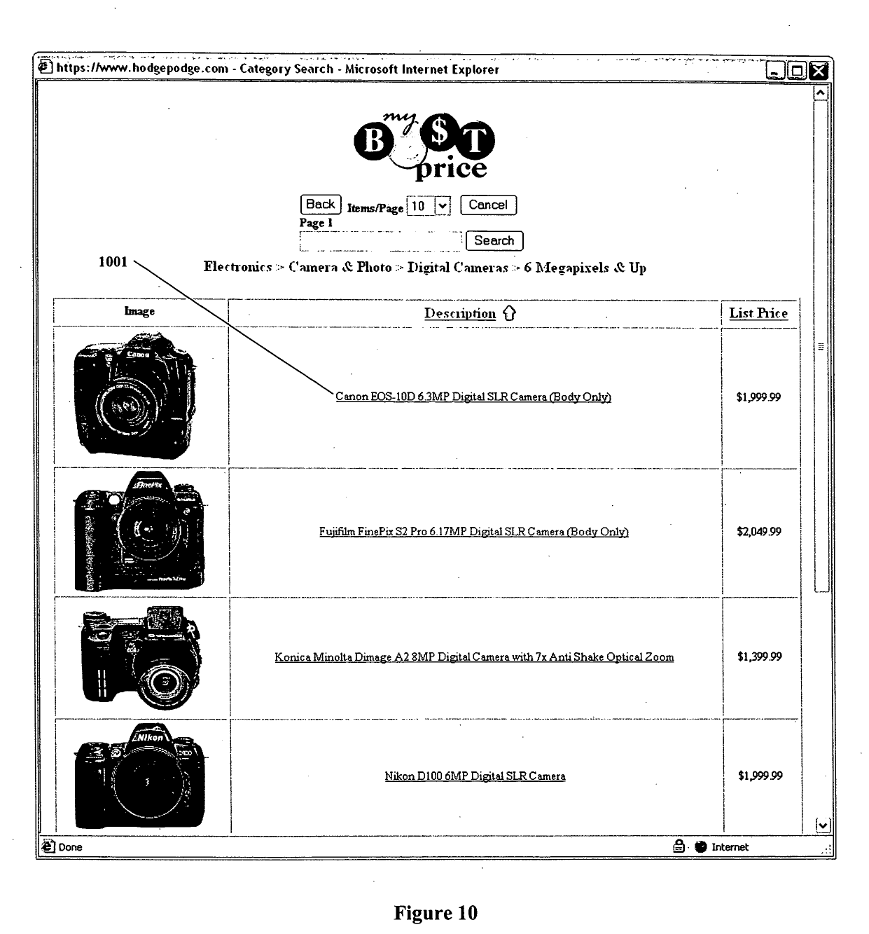

FIG. 11 is a screen shot of a web page that has just returned from a category search and has the requested item's UPC code inserted into the search field.

FIG. 12 is a screen shot of a web browser response to a unique item search request according to an embodiment.

FIG. 13 is a printout that a customer would receive from the provider that pertains to a desired grocery store. The printout shows the customers grocery list and the store floor plan according to an embodiment.

FIG. 14 is a flow diagram depicting an approach for a merchant to upload all of its physical store addresses as well as its items and item in store locations according to an embodiment.

FIG. 15 is a screen shot of a web page showing a multiple merchant location upload screen according to an embodiment.

FIG. 16 is a screen shot of a web page showing a multiple item upload screen according to an embodiment.

FIG. 17 is a diagram showing how the customer and merchant access the provider's web server, XML/SOAP server and phone server according to an embodiment.

FIG. 18 is a flow diagram of the events that take place on the provider's server in order to process an item selection criteria search request according to an embodiment.

FIG. 19 is a flow diagram of the events a customer needs to perform in order to create and or add items to their registry according to an embodiment.

FIG. 20 is a flow diagram depicting the events a customer performs in order to price compare items in their grocery list registry according to an embodiment.

FIG. 21 is a screen shot of a web page showing a price comparison request of a customers grocery list register according to an embodiment.

FIG. 22 is a picture showing a person using a web enabled cell phone with UPC scanner according to an embodiment.

FIG. 23 is a diagram of the internal components of a Web Server and its external connections according to an embodiment.

### DETAILED DESCRIPTION OF THE INVENTION

An embodiment of a unique item descriptor could be but is not limited to the following examples: A UPC (Universal Product Code) is a unique item descriptor. A unique UPC represents a unique item. There should only be one unique UPC assigned by manufactures to each unique product that is sold by merchants. We will not discuss further or go into detail about how and where a UPC is to be used; this information would be known by one of ordinary skill in the art. Another unique item descriptor could be an RFID (Radio Frequency Identification) tag. A unique RFID tag represents a unique item. There should only be one unique RFID tag assigned by the manufactures to each unique product that is sold by merchants. We will not discuss further or go into detail about how and where a RFID tag is to be used, this information would be known by one of ordinary skill in the art. Another unique item descriptor could be an MPN (Manufacture Part Number). A unique MPN represents a unique item. There should only be one unique MPN assigned by manufactures to each of the products they manufacture. A unique ISBN (International Standard Book Number) represents a unique item. There should only be one unique ISBN assigned by the manufactures to each unique product that is sold by merchants. We will not discuss further or go into detail about how and where an ISBN is used, this information would be known by one of ordinary skill in the art.

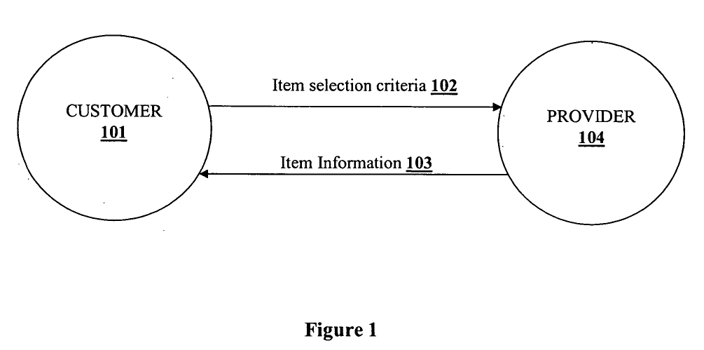

As used herein, the term “item(s)” refers to any goods that can be sold, rented or loaned to customers. Customers 101 may create lists of items using one or more unique item selection criteria 102 separate from submitting a list to the provider 104 for lookup using the current selection criteria as shown in FIG. 1. The provider then returns information based on the request back to the customer 103.

According to another embodiment, if a peripheral device supports a Graphical User Interface (GUI) then that is the preferred method of entering and receiving information to and from the provider.

Provider is illustrated as a single entity for the purposes of explanation only. Provider may be centralized or distributed depending upon the requirements of a particular embodiment. For example, provider may be a centralized server(s) or may be distributed across a network of clustered server(s).

In the following description, for the purposes of explanation specific details are set forth in order to provide a thorough understanding of this embodiment. However, it will be apparent that this embodiment may be practiced without these specific details described below. Accordingly in this aspect of the embodiment, a method is provided for retrieving information on items from merchants via the provider for customers.

According to one embodiment, one or more item selection criteria are received, through a medium (Internet, phone line, etc.), by the provider that indicate one or more unique items, which a customer desires to receive information on. The provider will deliver, according to this embodiment, through a medium, (Internet, phone line, etc), a sorted list by location and/or price for each desired item. The customer may then select one or more item(s)/location(s) supplied by the provider to receive more detailed information (Address, phone number, Street Map, Stock status, In Store Location, etc.).

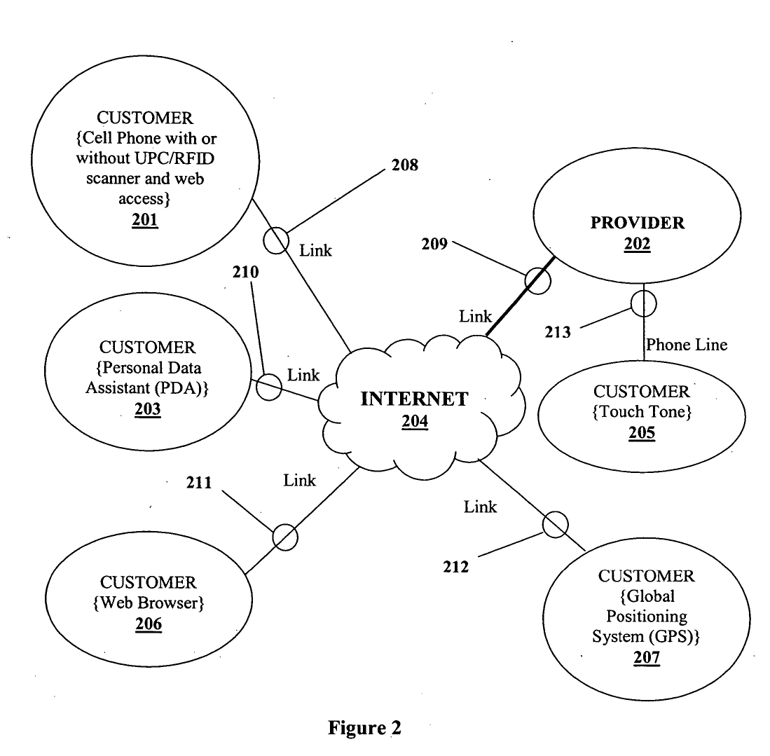

Customers communicate with the provider over links 208-212 the global packet-switched network referred to as the “Internet”204 as shown in FIG. 2. Links, in this embodiment may be any medium for transferring data between customers and the Internet and the provider 202 respectively. This embodiment is not limited to any particular medium. In the present example links may be connections provided by one or-more Internet Service Provider(s) (ISP) and customers. Customers can use but are not limited to standard telephone(s) 205 using a standard phone line 213, non web enabled cell phone(s) using touch tone/speech recognition technologies, generic Internet web browser(s) 206, web enabled cell phone(s) 201, Personal Data Assistant(s) (PDA) 203, Global Positioning System (GPS) device(s) 207 with or without a UPC or RFID equipped scanner. Links may be secure or unsecured, depending upon the requirements of a particular embodiment.

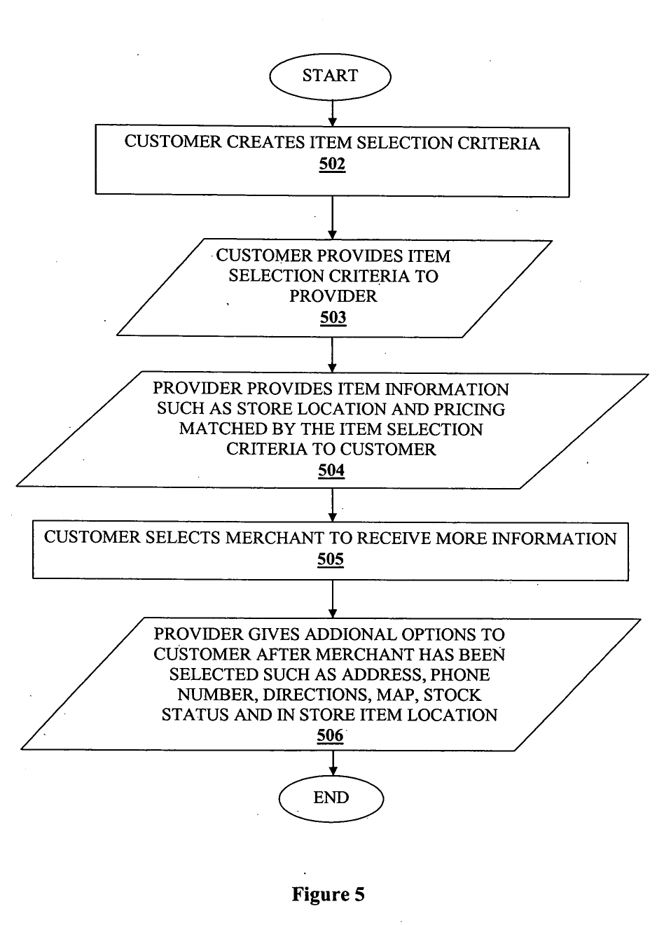

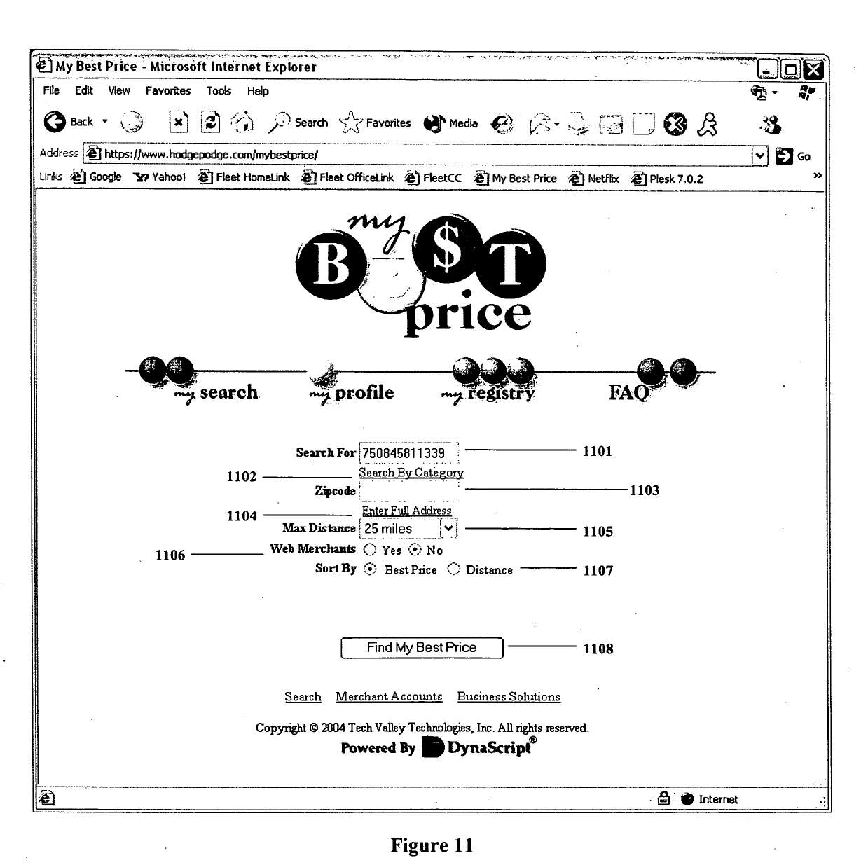

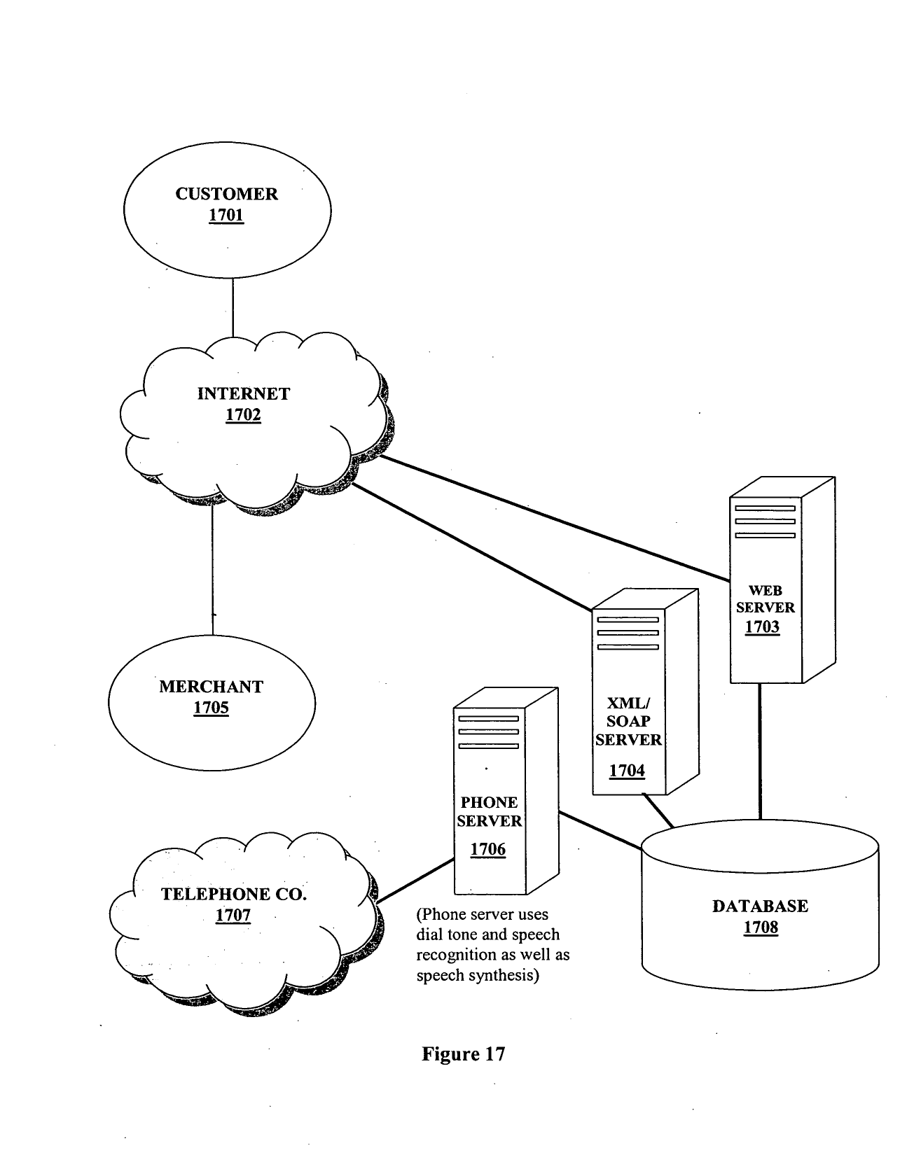

The present application employs several types of devices to communicate with the provider's computer server(s) 1703 & 1704 over the Internet 1702 as shown in FIG. 17. The present application is not limited to utilizing such said devices, but are given by way of example. A customer may use a number of different devices to communicate with the provider's server(s) to extract the information they are looking for from the provider's databases 1708. One such device is a web enabled cellular telephone with or without a UPC/RFID scanner 201, equipped with a web browser that is able to connect to the internet 204 as shown in FIG. 2. A customer, would need to connect to the internet via their web browser equipped cellular telephone 201. Once connected to the Internet 204 a connection to the provider 202 would need to be established. The customer would then enter item selection criteria 502 into the web browser of their cellular telephone as shown in FIG. 5. Item selection criteria may include but is not limited to a unique item descriptor 1101 such as a UPC or RFID, a zip code 1103, a max search distance 1105, type of merchants to be included 1106 and sort constraints 1107 as shown in FIG. 11. The item selection criteria would then be sent to the provider 503 via the cellular telephone connection as shown in FIG. 5.

Another such device to communicate with the provider's server(s) could be a wireless, web enabled PDA (Personal Data Assistant) with or without a UPC/RFID scanner 203 as shown in FIG. 2. The PDA would need to be equipped with a web browser that is capable of connecting to the internet Once connected to the internet a connection to the provider 202 would need to be established. The customer would then enter item selection criteria 502 into the web browser of their wireless PDA as shown in FIG. 5. Item selection criteria may include but is not limited to a unique item descriptor 1101 such as a UPC or RFID, a zip code 1103, a max search distance 1105, type of merchants to be included 1106 and sort constraints 1107 as shown in FIG. 11. The item selection criteria would then be sent to the provider 503 via the wireless PDA's wireless connection according to this embodiment as shown in FIG. 5.

Another such device to communicate with the provider's server(s) could be a PC or Macintosh computer 206 as shown in FIG. 2. The PC or Macintosh computer would need to be equipped with a web-browser that is capable of connecting to the internet. Once connected to the internet a connection to the provider 202 would need to be established. An internet connection could be facilitated through but is not limited to one of the following types of connections; a modem on a standard telephone line, a T1 line, a DSL line or coaxial cable connection. The customer would then enter item selection criteria 502 into the web browser on their computer as shown in FIG. 5. Item selection criteria may include but is not limited to a unique item descriptor 1101 such as a UPC or RFID, a zip code 1103, a max search distance 1105, type of merchants to be included 1106 and sort constraints 1107 as shown in FIG. 11. The item selection criteria would then be sent to the provider 503 via the computers internet connection according to this embodiment as shown in FIG. 5.

Another such device to communicate with the provider's server(s) could be a non-wireless touch tone telephone 205 as shown in FIG. 2. The touchtone telephone would connect to the providers telephone server(s) 1706 via a local telephone company's connection 1707 as shown in FIG. 17. Once connected to the providers server(s) the customer would enter item selection criteria 502 via the key pad on their telephone or through speech recognition technologies as shown in FIG. 5. Item selection criteria may include but is not limited to a unique item descriptor 1101 such as a UPC or RFID, a zip code 1103, a max search distance 1105, type of merchants to be included 1106 and sort constraints 1107 as shown in FIG. 11. The item selection criteria would be entered by the user as prompted by the providers interactive voice assisted phone server(s) 1706 according to this embodiment as shown in FIG. 17.

Another such device to communicate with the providers server(s) could be a wireless GPS (Global Positioning System) unit, with or without a UPC/RFID scanner 207 as shown in FIG. 2. The GPS unit would need to be equipped with a web browser that is capable of connecting to the internet. Once connected to the internet a connection to the provider 202 would need to be established. The customer would then enter item selection criteria 502 into the web browser of their wireless GPS unit as shown in FIG. 5. Item selection criteria may include but is not limited to a unique item descriptor 1101 such as a UPC or RFID), longitude and latitude, a max search distance 1105, type of merchants to be included 1106 and sort constraints 1107 as shown in FIG. 11. The item selection criteria would then be sent to the provider 503 via the wireless web browser enabled GPS unit according to this embodiment as shown in FIG. 5.

Another such device to communicate with the provider's server(s) could be a wireless non web enabled cellular telephone. The wireless non web enabled cellular telephone would connect to the providers telephone server(s) 1706 via a local telephone company's connection 1707 as show in FIG. 17. Once connected to the providers server(s) the customer would enter item selection criteria 502 via the key pad on their cellular telephone or through speech recognition technologies as shown in FIG. 5. Item selection criteria may include but is not limited to a unique item descriptor 1101 such as a UPC or RFID, a zip code 1103, a max search distance 1105, type of merchants to be included 1106 and sort constraints 1107 as shown in FIG. 11. The item selection criteria would be entered by the user as prompted by the providers interactive voice assisted phone server(s) 1706 according to this embodiment as shown in FIG. 17.

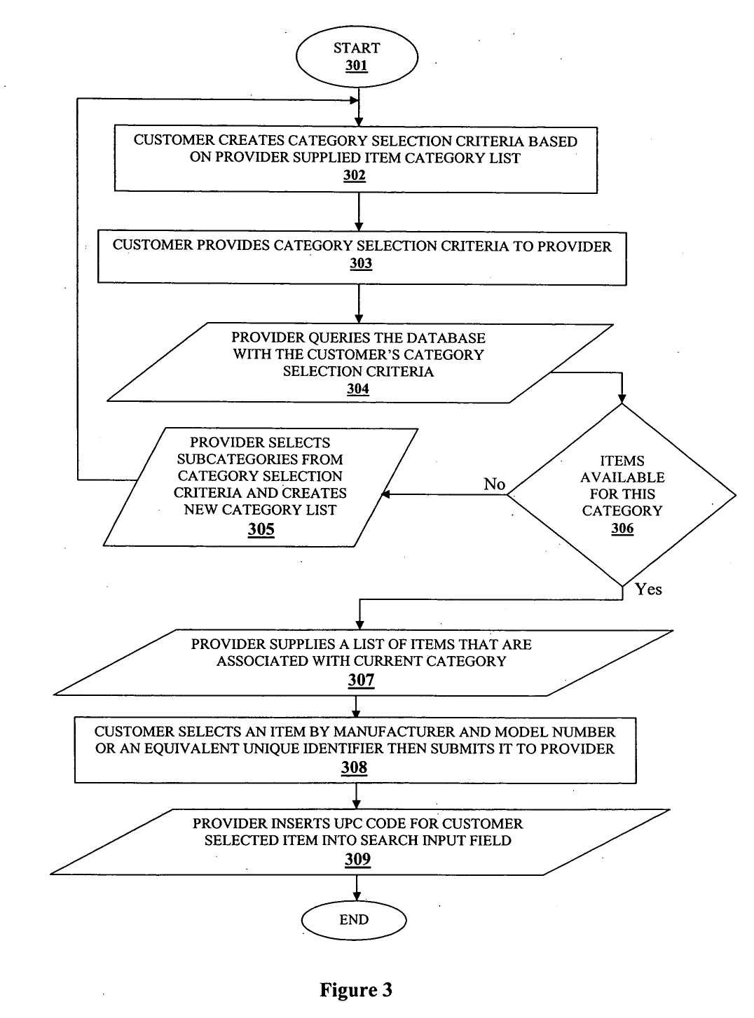

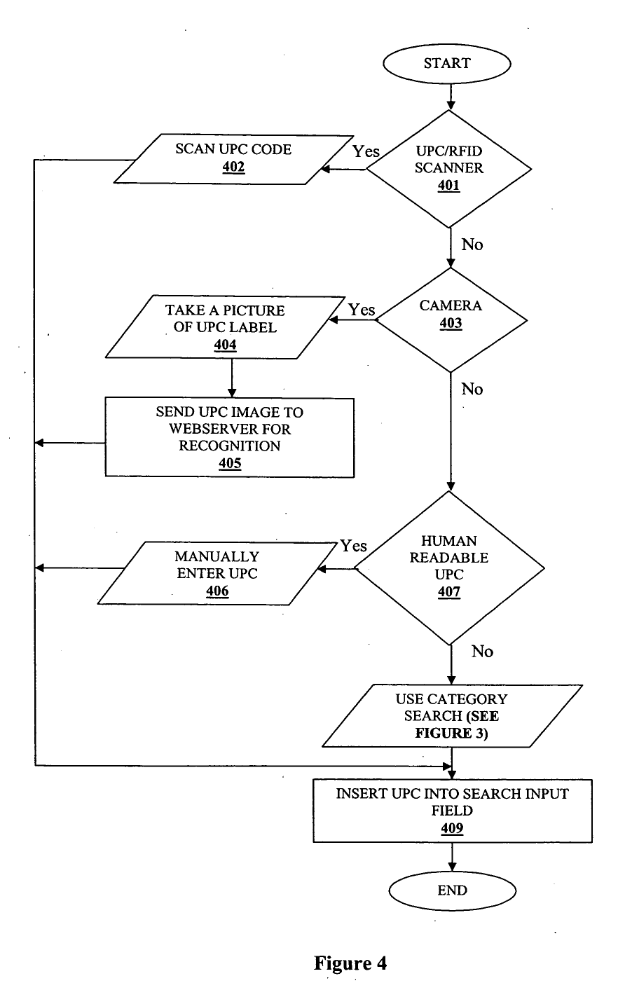

accordance with an embodiment, customers having a web enabled cell phone can scan a UPC 402 code if they have a UPC or RFID scanner 401 as shown in FIG. 4. Or the customer can take a picture 404 of the UPC label if they have an embedded camera 403 in their cell phone, PDA, etc. The image can then be sent to the provider's web server 405 for recognition and the recognized UPC number can be returned and entered into the search input field 409. Otherwise if the UPC is human readable 407 the customer can manually enter the UPC using touch tone or speech recognition technologies 406. If the UPC is not human readable the customer can use the category search technique 408 as described in FIG. 3.

In accordance with an embodiment, customers create and provide item selection criteria to the provider over links and the Internet. A customer 1701 can use but is not limited to using the communication devices described previously in Paragraphs 08-13, to communicate via links and the Internet as shown in FIG. 17. By way of example a customer may provide the following item selection criteria's using one of the communication devices previously mentioned in Paragraphs 08-13 as shown in FIG. 11:
Search For=UPC: 731004123450 (1101), Zip code=93442 (1103), Max Distance=25 mi.(1105), Web Merchant=No (1106), and Sort By=Best Price (1107)
Search For=Keyword: Gas (1101), Zip code=12833 (1103), Max Distance=25 mi.(1105), Web Merchant=No (1106), and Sort by=Distance (1107)
Search For=ISBN: 0-78920538-6 (1101), Zip code=93442 (1103), Max Distance=25 mi.(1105), Web Merchant=No (1106), and Sort by=Best Price (1107)
Search For=MPN: DVP-CX985V (1101), Address=54 Wilton Road (1104), City=Greenfield (1104), State=NY (1104), Zip code=12833 (1103), Max Distance=25 mi.(1105), Web Merchant=No (1106), and Sort by=Distance (1107)
Search For=AD-HOC Expression: Canon camera (1101), Zip code=12833 (1103), Max Distance=25 mi.(1105), Web Merchant=No (1106),and Sort by=Distance (1107)
Search For=EAN: 9780446528382 (1101), Latitude=43.1289, Longitude=73.8570 (1104), Max Distance=25 mi.(1105), Web Merchant=No (1106), Sort by=Best Price (1107)

In accordance with this embodiment of the approach, a customer communicating with the provider to search for an item by unique item descriptor could use but is not limited to the following routine; A customer creates item selection criteria 502 as shown in FIG. 5. Customer then provides item selection criteria to the provider 503. Once customer has sent the item selection criteria, through a link, to the provider, the provider will find all applicable information based on the customers item selection criteria and send that information back through a link to the customer. The provider provides item information such as store location and pricing that match the item selection criteria to the customer 504. Customer selects a merchant to receive more information on 505. The provider then gives additional options to the customer after the merchant has been selected such as: address, phone number, directions, map, stock status, and in store item location 506.

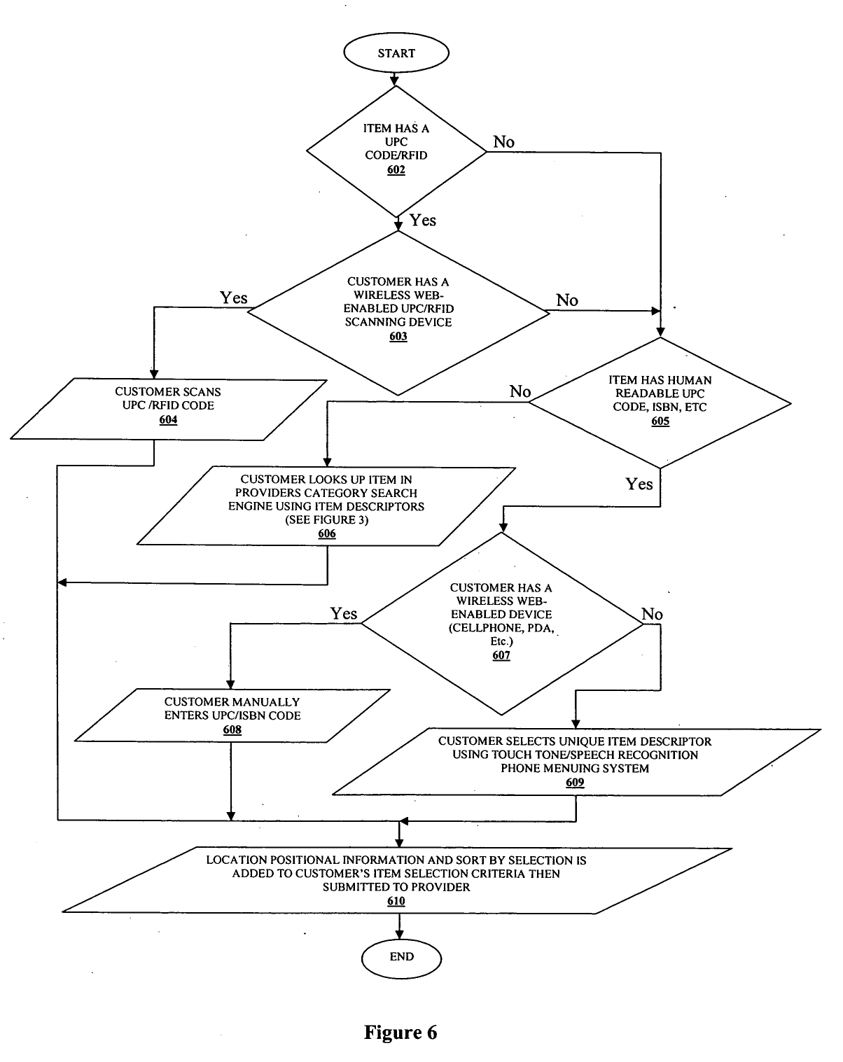

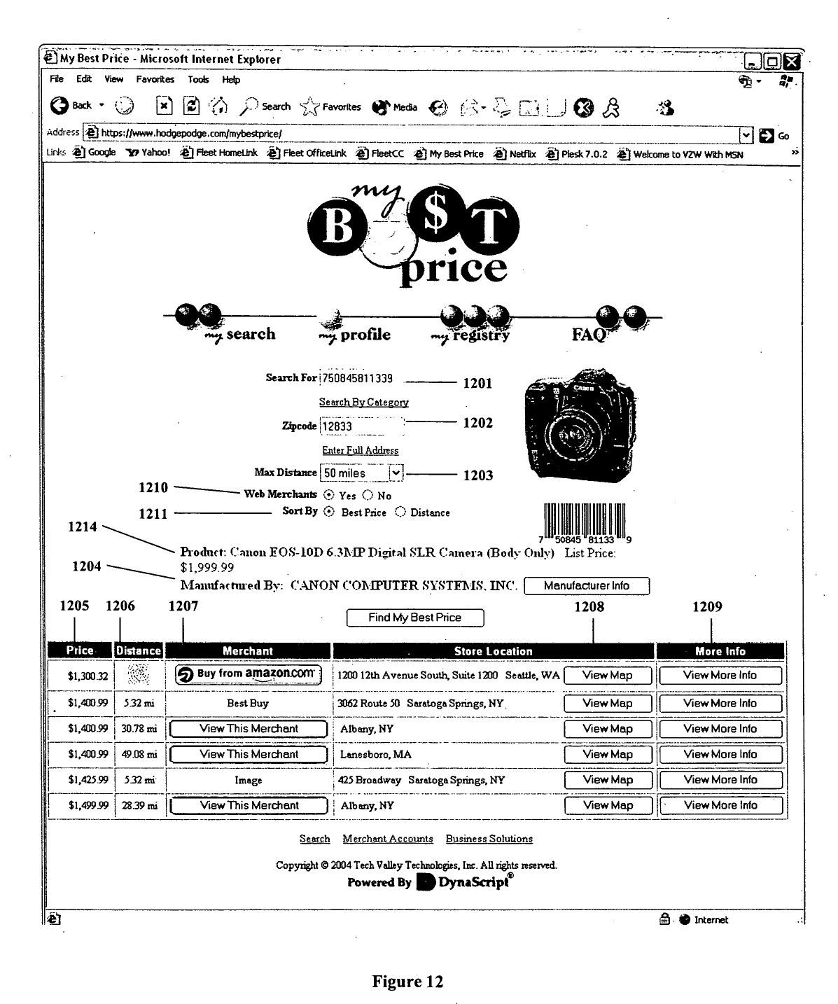

In accordance with this embodiment of the approach, a customer communicating with the provider to search for an item by unique item descriptor could use but is not limited to the following routine; The customer would enter the unique item descriptor desired into the search input field 1101, a positional point of reference 1103 or 1104, a maximum search distance 1105, type of merchants desired 1106, and sort by constraint 1107 as shown in FIG. 11. For example as described in FIG. 6, a customer enters a store and locates a desired item, if that item has a Radio Frequency Identification tag (RFID) or a Universal Product Code (UPC) 602 and the user has a portable wireless web enabled device with a RFID or barcode scanner capability 603, respectively, the user simply scans the unique item identifier 604 in to search field 1101 as shown in FIG. 11. If the user does not have a barcode scanner capable device and the UPC code has human readable barcode numbers 605 the user can manually enter 608 the UPC numbers on their cell phone or PDA 607 as shown in FIG. 6. If neither a barcode nor human readable UPC code exists the user can use a standard telephone 609 and use the touch tone/speech recognition based category search engine 606 as described in FIG. 3 to lookup the unique item descriptor. The customer then either enters address and or zip code of their current physical location in order to pinpoint their exact global position 610. This location information is used to derive their current latitude and longitude to be used for distance, proximity, directions, map, site, etc. Or the provider can automatically determine the customer's location by using the cell phone tower triangulation or GPS location for a point of reference. An item selection criteria is composed of a UPC or RFID number 1101 along with tie customer's current location 1103 or 1104, merchant type 1106, as well as the sort by information (Best Price or Distance) 1107 as shown in FIG. 11. The Customer then submits the item selection criteria by clicking the “Find My Best Price” button 1108. The search request is then sent through an internet link to the provider as an item selection criteria. The provider then returns a list of merchants that match the item selection search criteria 504 as shown in FIG. 5; Once the customer receives a list of merchants 1207, prices 1205, and relative distance 1206 from the provider this may conclude the item lookup or they may request additional information 1209 for this embodiment as shown in FIG. 12.

Because keywords are not unique by nature they will resolve to a unique item descriptor. Keywords can be assigned to unique item descriptors by merchants or by the provider. This embodiment is not limited to any particular approach for specifying and or binding Keyword(s) to a item selection descriptor.

In one embodiment of the approach when a Keyword or Ad-Hoc expression is used in the search Field 1101 as shown in FIG. 11, the provider's web server compares the search field to all keywords already assigned a unique identifier as shown in. If the keyword is an exact match the provider will insert the assigned unique identifier in the Search field 1101. If the search field is an Ad-Hoc expression and is not assigned to a unique identifier the provider will return to the customer a list of items sorted by relevance. Relevance for an item could be measured in a multitude of different ways. For example, the provider could return a list of 100 items the most relevant item being on the top of the returned list with the following relevancy values: Item has the most inquires by customers (most popular), and or item is in stock at merchants within a specified distance, and or item is the best price at merchants within a specified distance in comparison to other like items within the same specified distance, and or item is sponsored in the providers database by a merchant(s). These values are calculated by the provider's internal metrics and weighted, and then sorted from most relevant to least relevant. The item at the bottom of the list of 100 relevant items would have the least relevant values at that specific time. Sponsored item(s) in the provider's database can be favored and displayed more prominently than items that are not sponsored. Relevant values will be constantly changing depending on the many factors that go into them. The provider will monitor and record the constantly changing data so that real time inquires (searches) are as accurate as possible at any given time.

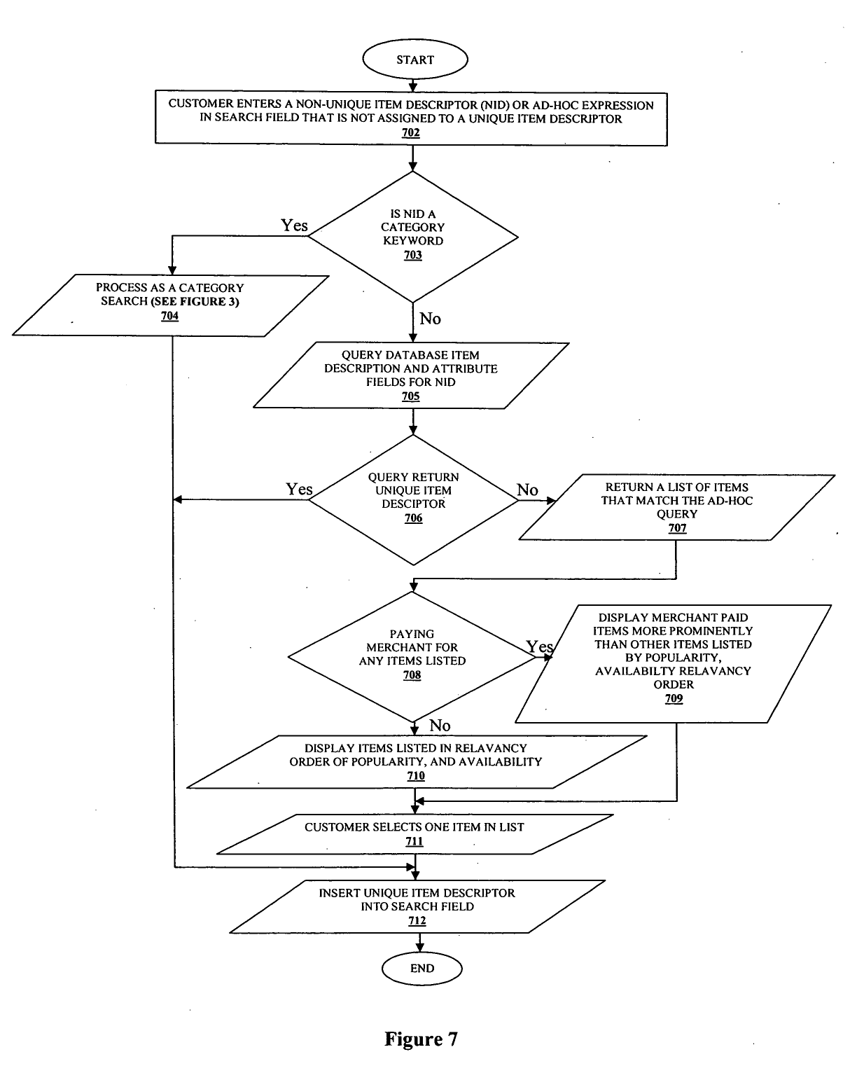

In accordance with this embodiment of the approach, a customer can enter into the search field 1101 as shown in FIG. 11, an Ad-Hoc expression that is a non-unique item descriptor 702 as described in FIG. 7. In this embodiment the provider is not limited to but can process the input using the following steps: First the input is compared to category key words using standard Boolean search techniques 703. If there is a match, the customer will use the category search engine 704 as described in FIG. 3 to select the unique item descriptor. If there is no match the provider will build a database query 705 that will perform a Boolean search against the item description and attribute fields. If a unique item descriptor is returned 706 from that query then it is inserted into the search field 712. Otherwise a list of items matching the query are returned 707. That list of items is then compared against the list of paying merchants 708, popularity, and availability (stock status) to determine the displayed order. If any of the items in the listed are sponsored by paying merchants they are presented to the customer in a more prominent manner 709. Otherwise they are sorted using a relevancy of popularity and availability or number of items in stock 710. The customer must then select the item they desire from that list 711 and the corresponding unique item descriptor will be loaded into the search field 712.

In this embodiment a customer may store their own wish list of items on the provider's web site and access the item descriptors for each unique item using their own personal registry. Customers can create multiple registries i.e. Wedding, Shower, Birthday, Christmas, Shopping, Wish List or Grocery List, etc. This account may be secured or unsecured depending upon the requirements of a particular embodiment. In this embodiment a similar function can be found with the personal registry where a customer can walk around to different stores collecting unique item descriptors for desired items to upload into their own personal registry. They then may setup a separate login and password that they give to friends and family to access those registries. Friends and family can access the list from the provider by using a web browser, cell phone, PDA, etc. Friends and family can also print out a listing of each item with its corresponding unique identifiers and bring the list with them shopping. Or using a web enabled device they simply select a unique item descriptor from the registry and request, along with their selection criteria, information from the provider. The provider will deliver across a link a sorted list based on added item selection criteria information.

A customer may not have exact item selection criteria for the search input field 1101 which is used for but not limited to such descriptors as a UPC, RFID, MPN, ISBN or a Keyword(s) as shown in FIG. 11. A customer can select the “Search By Category” 1102 link to search by category and find a unique item descriptor. A category search for an item will resolve to a unique item descriptor. The embodiment is not limited to any particular approach for specifying or providing a technique of searching categories that resolve to a unique selection descriptor.

In accordance with an embodiment, customers create and provide item category selection criteria to the provider over internet links. A customer can use but is not limited to using the communication devices described previously in Paragraphs 08-13, to communicate via internet links. For example a customer may provide the following category selection criteria's using one of the communication devices previously mentioned in Paragraphs 08-13 By way of example a “Search By Category” 1102 routine may result with the following as shown in FIGS. 801,901,1001 & 1101:
Category=Digital Cameras 801, Sub Category=6 Mega pixels & Up 901, Final Item Selection=Canon EOS-10D 6.3 MP Digital SLR Camera (Body Only) 1001 unique item descriptor=UPC 75084581133 1101.

In accordance with an embodiment of the approach, one example of a customer communicating with the providers “Search By Category” 1102 routine may include but is not limited to the following steps as shown in FIG. 11: A customer creates category selection criteria based on a provider supplied item category list 302 as described in FIG. 3. Customer then provides category selection criteria to the provider 303. Provider queries the database with the customer's category selection criteria 304. If items are not available for this category 306 provider selects subcategories from category selection criteria and creates a new category list 305 and starts back at the beginning of the category selection routine 301. If items are available for this category 306, the provider supplies a list of items that are associated with the current category 307. The customer then selects an item by manufacturer and or model number or an equivalent unique identifier then submits it to the provider 308. The provider inserts UPC, RFID, ISBN, MPN or other unique identifier into the search field 309.

Once an item selection is made from the provider's database 1708 as shown in FIG. 17 using the “Search by Category” 1102 function on a web browser, a unique item descriptor is given back to the customer as shown in FIG. 11. This unique item descriptor is automatically loaded into the search field 1101 for later submission by the customer to the provider. This unique Item descriptor along with the other parameters of FIG. 11 are used to compose a search item criteria.

Once all pertinent item selection criteria has been selected using but not limited to any of the previously mentioned customer interfaces as described in Paragraphs 08-13, a customer would then select the “Find My Best Price” button 1108 to submit their request to the provider.

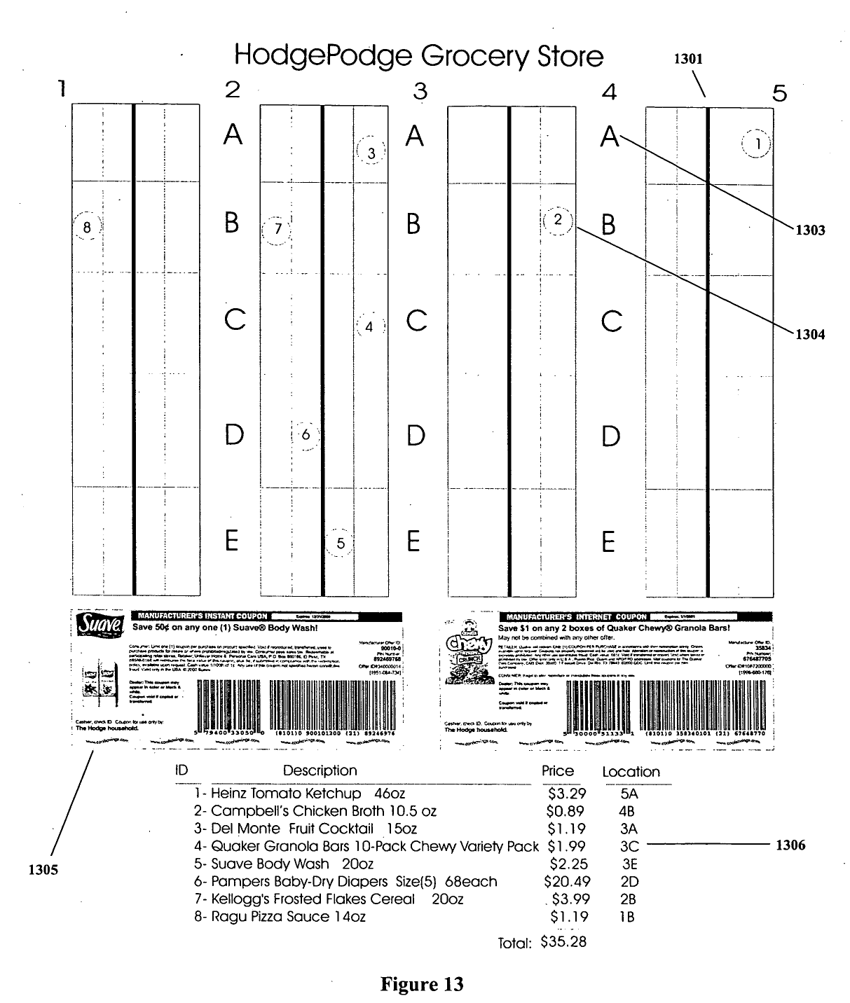

FIG. 12 is a screen shot that depicts an embodiment of the approach a provider uses to respond to a customers item selection criteria search request. The customer entered in a unique identifier of the desired item 1201, a positional reference point (zip code) 1202, sort by option 1211, web merchant option 1210, and maximum distance proximity constraint 1203 for the item selection criteria. The response showing the price 1205, distance 1206, merchant 1207, location 1208, description 1214, and more info button 1209, was generated by the provider and delivered to the customer across a link to their web enabled device or web browser. Each line of the listing designates a price and location of the desired item. The listings that include the merchant name are merchants that have chosen to pay the flat rate pay-per-item (PPI) billing option. The listings that include the “View This Merchant” button 1207 are merchants that have chosen the pay-per-click (PPC) billing option. In this embodiment the customer can click on one of the “View Map” buttons 1208 to view a street map showing them how to get to the designated store from where they are currently located. The customer clicks on the “View More Info” button 1209 to view the floor plan as shown in FIG. 13 of the designated store and an indicator showing where in the store the desired item(s) are located as well as if the item(s) is currently in stock. If the desired item is out of stock the customer can request an email notification of when the item is available at that store location.

FIG. 13 is a printout that a customer would receive from the provider that pertains to a desired grocery store. The printout shows the customers grocery list and the store floor plan. On the floor plan the isle 1301 includes shelves with designators 1303 that uniquely identify product location within the store. In this embodiment the provider will generate the floor plan map of the desired store and the locations in that store where each item is located 1304. The provider can also embed applicable coupons 1305 in the floor plan map or separately for customer's desired items. If the customer desires the provider can also supply the customer with a list on their cell phone, PDA, or GPS unit of each item with its corresponding location designator 1306 (e.g. Ketchup-5A, Chicken Soup-4B) queued up and ordered by the most efficient route through the store. If the customer does not have a web enabled cellular telephone they can use the providers interactive touch tone voice based menu driven interface to direct them to items throughout the store.

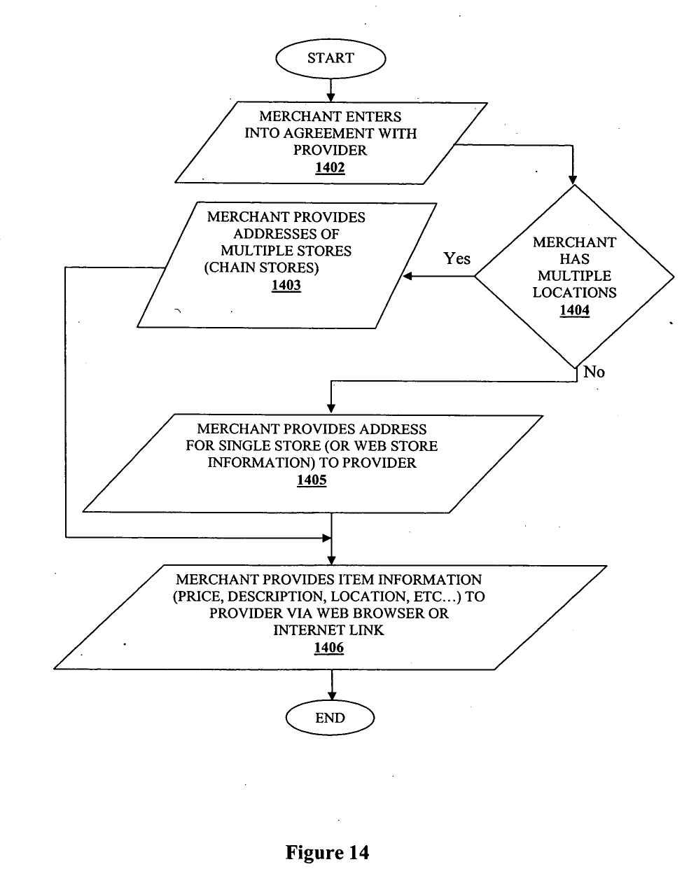

FIG. 14 is a flow diagram that depicts an embodiment of the approach a merchant uses to access the providers service. This approach shows a few of the steps in setting up a new merchant on the providers system. The first step is that a merchant would enter into an agreement with the provider 1402. If the merchant has only one location or they have only a web store or mail order location 1404 then the merchant uploads that location and associated information 1405. If the merchant has multiple locations 1404, the merchant could upload multiple locations and associated information of their stores 1403. The merchant then uploads all of the items and associated item information 1406 such as but not limited to; Price, Description, Stock Status, In store Location, etc. There are several ways that a merchant can upload their store and item information to the provider. One embodiment is, but is not limited to the provider having an XML (Extended Markup Language) or SOAP (Simple Object Access Protocol) server to receive information from the merchant. Another embodiment of data exchange with merchants is, but is not limited to polling the information from the merchant's server.

As part of the provider and merchant agreement, in this embodiment the merchant chooses a payment option offered by the provider for their services. Two possible options are given by way of example and are not the only payment options available. One option would be a pay-per-item (PPI) method whereas the merchant would pay the provider a flat fee based on the number of items and number of stores the merchant uploaded to the provider. A second option would be a pay-per-click (PPC) method whereas the merchant would pay a fee to the provider based on the number of items and stores uploaded to the provider. In addition, the merchant would also pay for each merchant link 1207 clicked on by a customer as shown in FIG. 12.

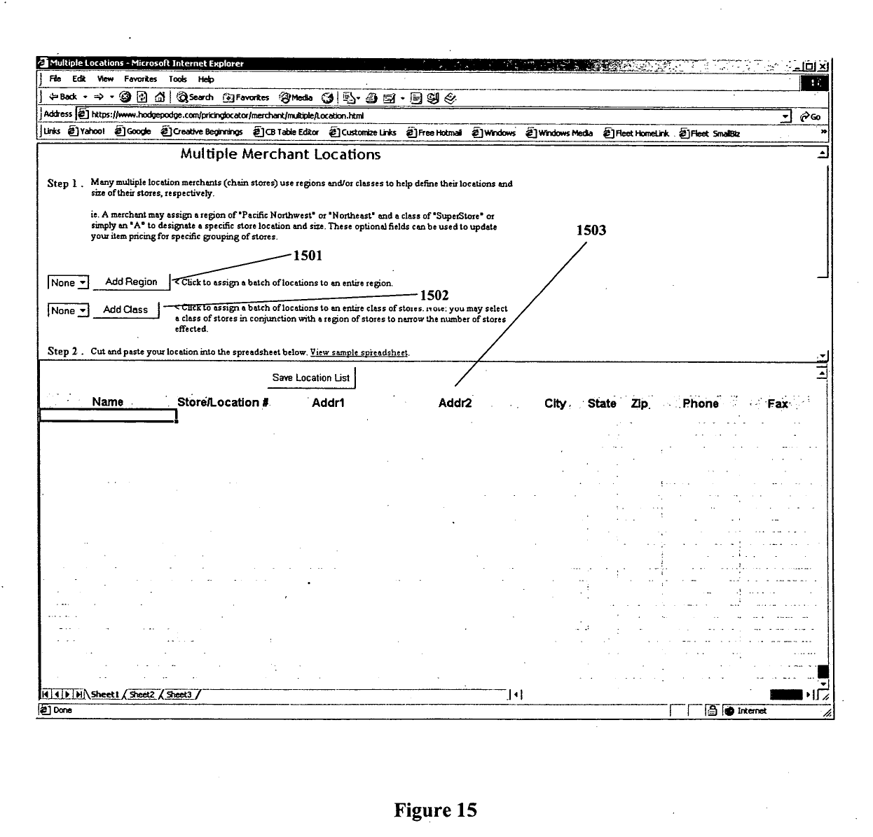

FIG. 15 is a screen shot of a web browser that depicts an embodiment of the approach a provider uses to have a merchant upload all of their store locations. A Region designator 1501 is used to describe a grouping of stores located with certain proximity of each other. For example Regions could be described as “Nationwide”, “North East”, “North West”, or “New York City”, “Phoenix Ariz.”, etc. A Class designator 1502 is used to describe a type of store based on certain attributes. For example Class designators could be described as “Super Store”, “Regular Store”, “Outlet Store”, or simply “Class A”, “Class B”, etc. The merchant creates and selects an applicable Region and Class that pertains to the batch of store locations they are currently uploading to the provider. Steps are repeated for all unique combinations of Regions and Classes until all store locations 1503 are uploaded to the provider.

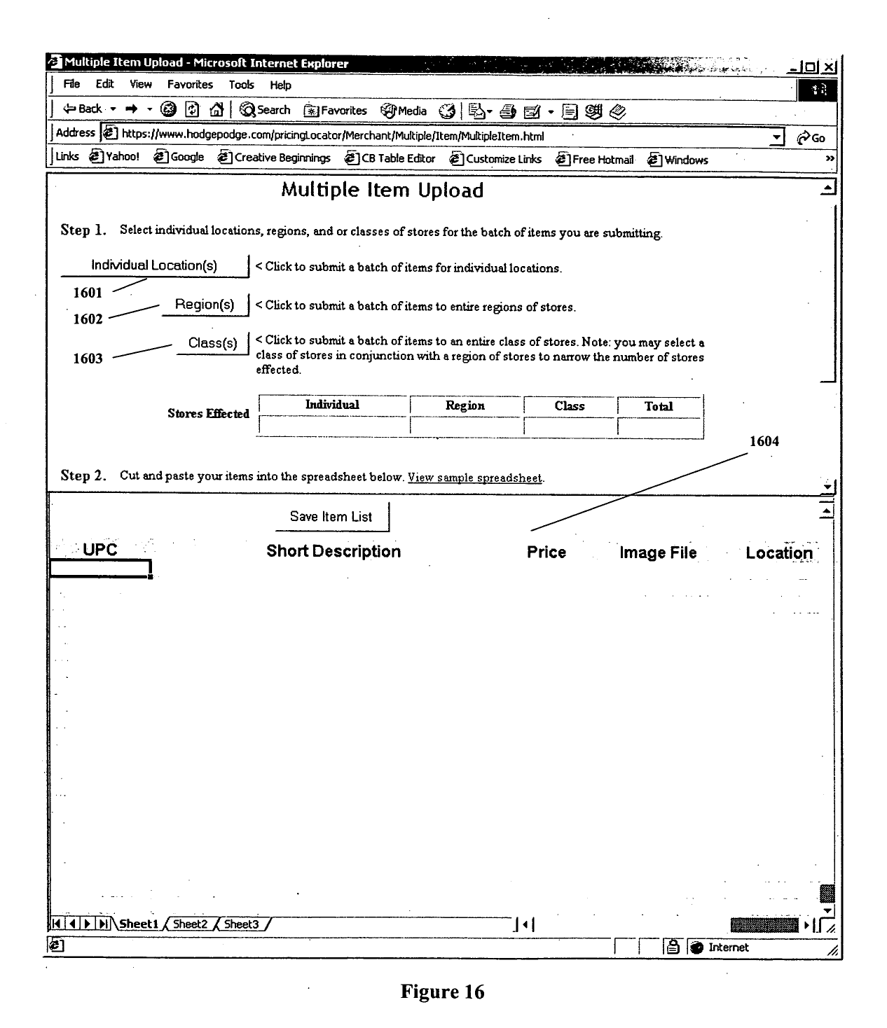

FIG. 16 is a screen shot of a web browser that depicts an embodiment of the approach a provider uses to have a merchant upload all the item information to each store groupings of Regions 1602 and Classes 1603. If a merchant desires to apply this item upload 1604 to one or more individual store location then the merchant presses the “Individual Location(s)” button 1601 and selects each and every store that the items inserted into the spreadsheet 1604 applies to. If the merchant desires to apply this item upload 1604 to a Region of store locations then the merchant presses the “Regions(s)” button 1602 and selects each and every Region that the items inserted into the spreadsheet 1604 applies to. If the merchant desires to apply this item upload 1604 to a Class of store locations then the merchant presses the “Class(s)” button 1603 and selects each and every Class that the items inserted into the spreadsheet applies to. If the merchant desires to apply this item upload 1604 to a combination of both Regions and Classes of store locations then the merchant presses both the “Region(s)” 1602 and the “Class(s)” 1603 buttons and selects each and every Region and Class that the items inserted into the spreadsheet 1604 applies to. By way of example a merchant could have the following groupings:
Region=“Nationwide”
Region=“North East” and “North West” and Class=“Super Store”
Region=“Nationwide” and Class=“All Stores”

FIG. 17 is a diagram that depicts an embodiment of the approach where both the customer 1701 and the merchant 1705 transfer information through the Internet 1702 to the providers Web Server 1703. In this embodiment the providers Web Server 1703 will process store address upload/update request from a merchant 1705 by transferring their list of store address 1503 to the Database 1708. The providers Web Server 1703 will process item upload/update request from a merchant 1705 by transferring their list of items 1604 as shown in FIG. 16 to the Database 1708, FIG. 17 and associate them with each applicable store location 1503 as shown in FIG. 15.

In this embodiment when a customer sends an item selection criteria request, the item search criteria includes, a unique item descriptor (UPC, ISBN, EAN, RFID, etc) 1101, a positional point of reference identifier (Address 1104 or Zip code 1103 or Latitude, Longitude 1104), maximum search distance constraint 1105, type of merchant 1106, and a sort by option (Price, Distance) 1107 as shown in FIG. 11 are transferred to the Web Server 1703. The Web Server 1703 then builds and submits, using known database algorithms, a query to the database 1708 requesting all matching records based on the customer's item selection criteria as shown in FIG. 17. Each item that matches the query is returned to the Web Server 1703 and formatted into a web page by the Web Server 1703 then sent back to the customer 1701.

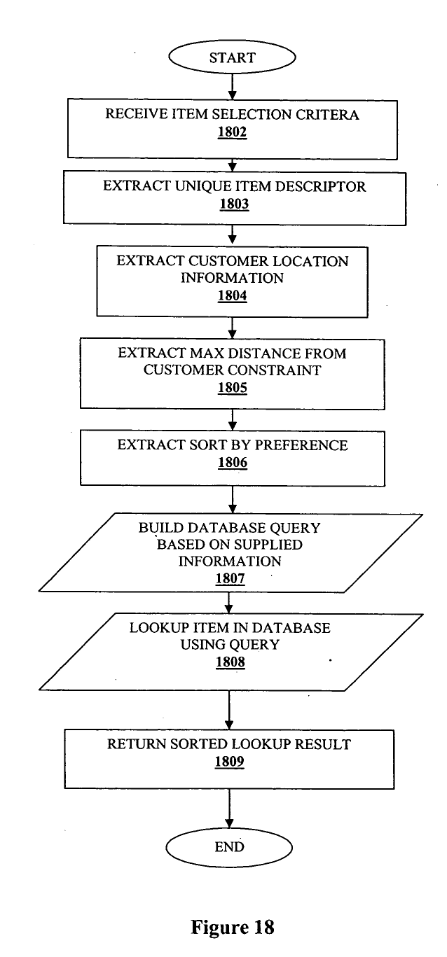

FIG. 18 is a flow diagram that depicts an embodiment of the approach of the events that take place on the provider's web server in order to process an item selection criteria lookup request. Once the providers web server receives an item selection criteria lookup request 1802 it extracts the unique item descriptor 1803, the customer location 1804, maximum distance constraint 1805 and sort by preference 1806 used in building the database query. The database query is constructed from the item selection criteria 1807 and submitted to the database engine. The database engine will then look up the item in the database using the query 1808. The web server will then return the requested information 1809 from the database to the customer via an internet link.

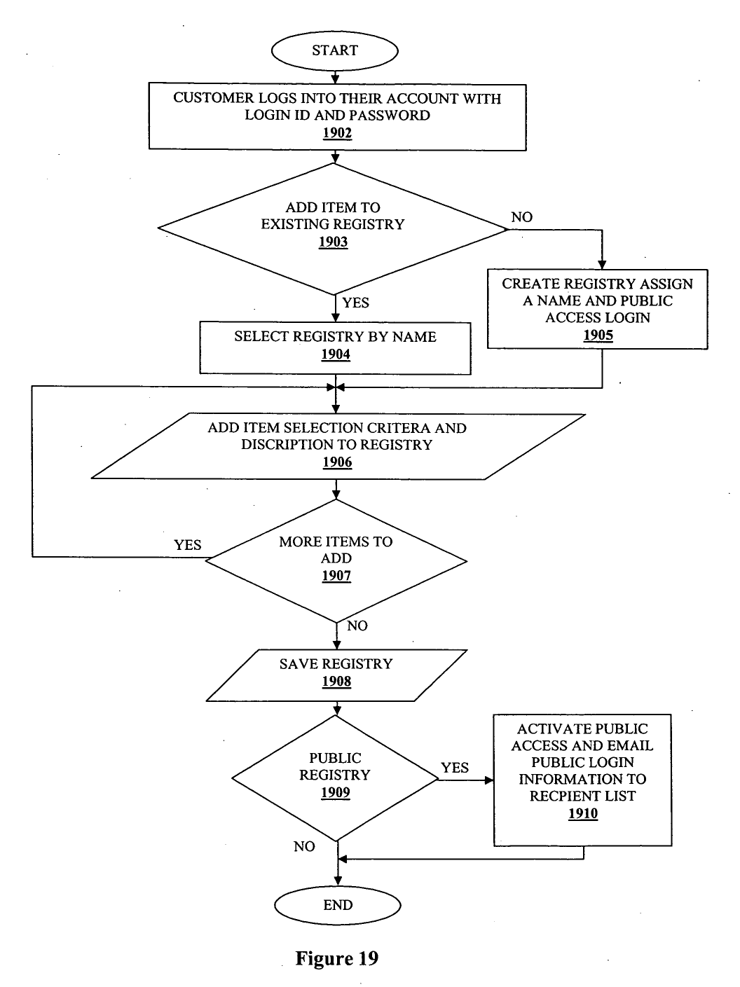

FIG. 19 is a flow diagram that depicts an embodiment of the approach of the events a customer needs to perform in order to create and or add items to their registry. The customer first logs in to their account with a login ID and password 1902, if they have already created a registry they simply request it by name 1904. If they have not yet created a registry then they would create one and assign it a unique name 1905. The customer would then enter in the unique item descriptor 1903 using the techniques described in paragraph [16]. Once they have completed adding 1907 all desired unique item descriptors 1906 they would save the registry either on their device (Cell Phone, PDA, GPS system, etc.) on their machine as a web browser cookie and/or on the provider's server 1908. In this embodiment if the list were to be accessed by friends and family the customer would create a list of email address of recipients to receive the private access login information for that registry 1910. Then the provider's server would allow access to the public registry 1909 via the public access login and would send emails out to all recipients accordingly.

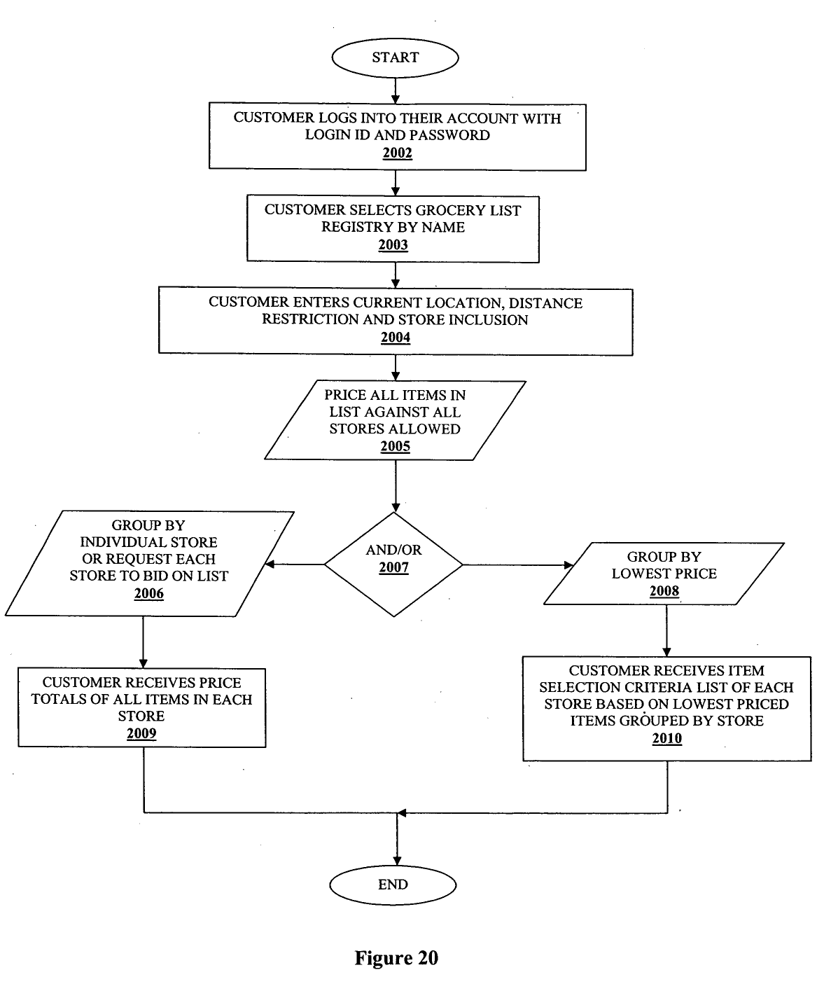

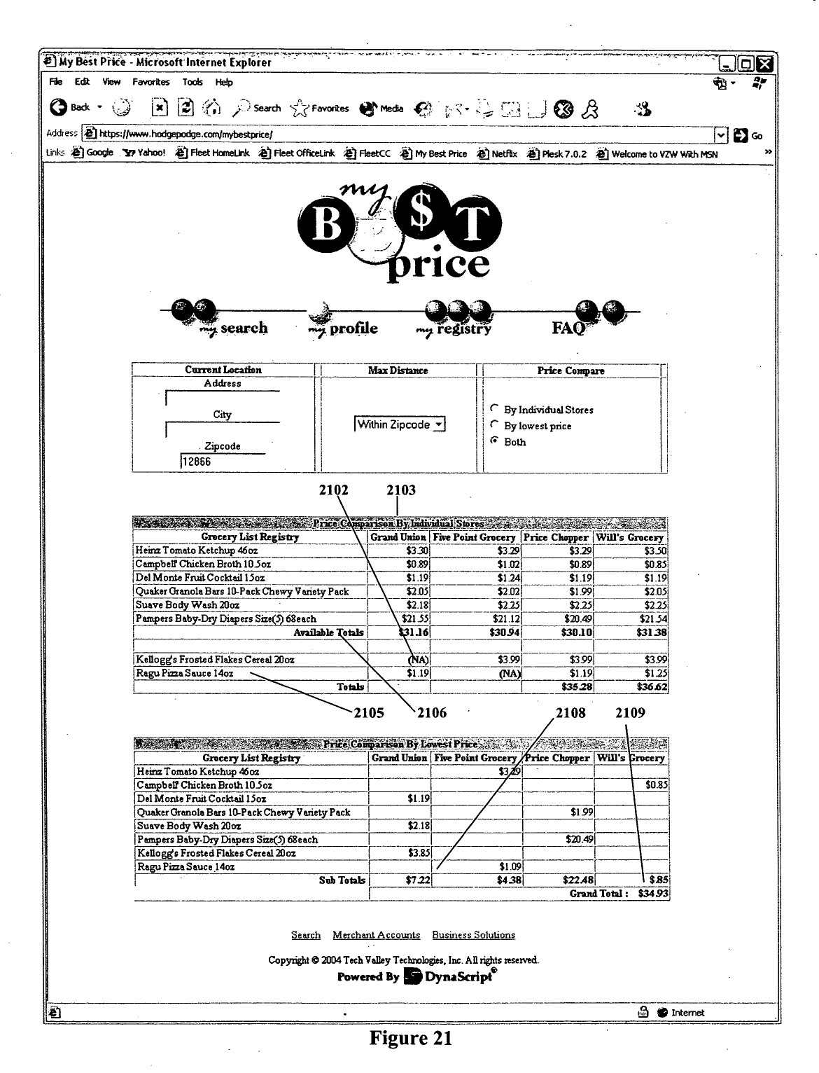

FIG. 20 is a flow diagram that-depicts an embodiment of the approach of the events a customer needs to performs in order to request a price comparison of items in their grocery list registry. In this embodiment the customer logs into their account with login ID and password 2002 and selects the grocery list registry by name 2003. The customer then enters in their positional point of reference, maximum distance constraint and store inclusion criteria 2004. In this embodiment a typical maximum distant constraint could be a mile radius from customer, a town, city, or state boundary. In this embodiment a typical store inclusion criteria could use the max distance constraint to determine inclusion, a maximum count of stores, or select them from a preferred list of stores 2005. The customer then decides whether to view the price comparison request as individual stores 2006 and/or lowest price 2007 to scan across stores looking for the least expensive price of each item in the grocery list registry. In this embodiment if the customer chooses to view the comparison by individual stores a list of prices for each item is displayed for each store 2009. If the store does not have a particular item then a (NA) 2102 designator is displayed indicating that the item is not available at that store as shown in FIG. 21. All items that are not available in all stores are displayed below 2105. Item totals are only given for available items for true comparisons 2106. If the customer chooses to compare prices based on lowest price 2008 across a group of stores then the price comparison by lowest price chart will be displayed 2010. This chart reflects the lowest price for each item in the grocery list registry at the select group of stores 2103. In this embodiment if multiple stores have the same price for a particular item then only the closest store will have that item's price displayed. A subtotal of each stores price is displayed 2108 along with a grand total 2109. These totals show the customer what price they would pay for the list of groceries if they were to go to each store and purchase only the lowest priced items. The embodiment of price comparisons has been illustrated by way of example, and not by way of limitation.

FIG. 21 is a screen shot of a web page showing a result of a price comparison request of a customers grocery list register according to an embodiment. This depicts the results from the flow diagram of FIG. 20.

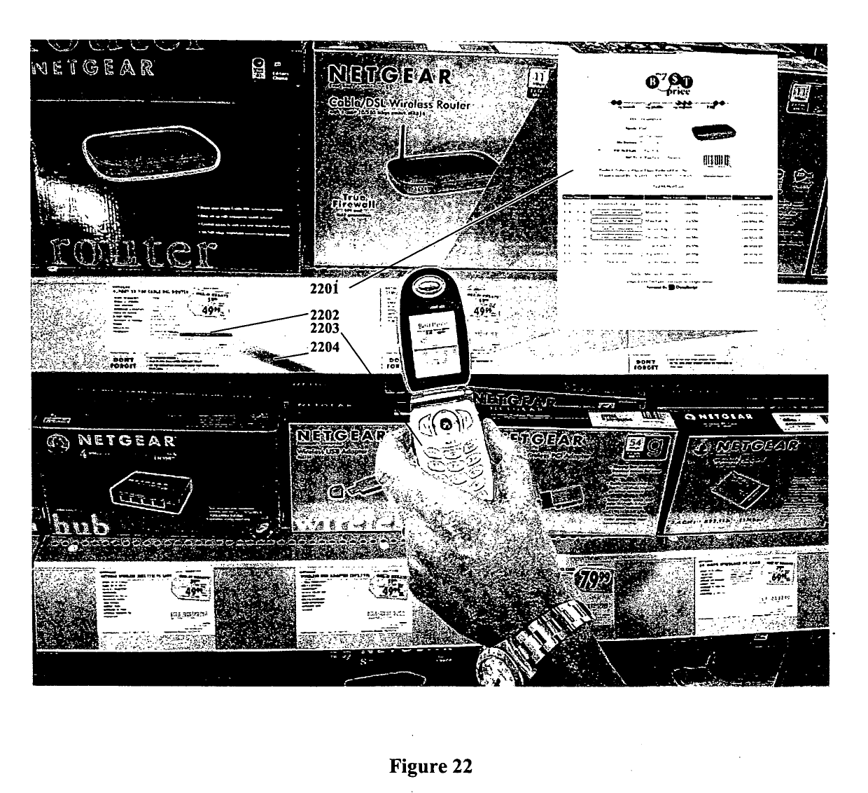

FIG. 22 is a picture that depicts an embodiment of a customer using a web enabled cell phone 2203 that has UPC scanning capability 2204. The customer would simply scan the barcode 2202 of the desired product and quickly get a listing of merchants and prices for the desired product within a 25 mile radius 2201.

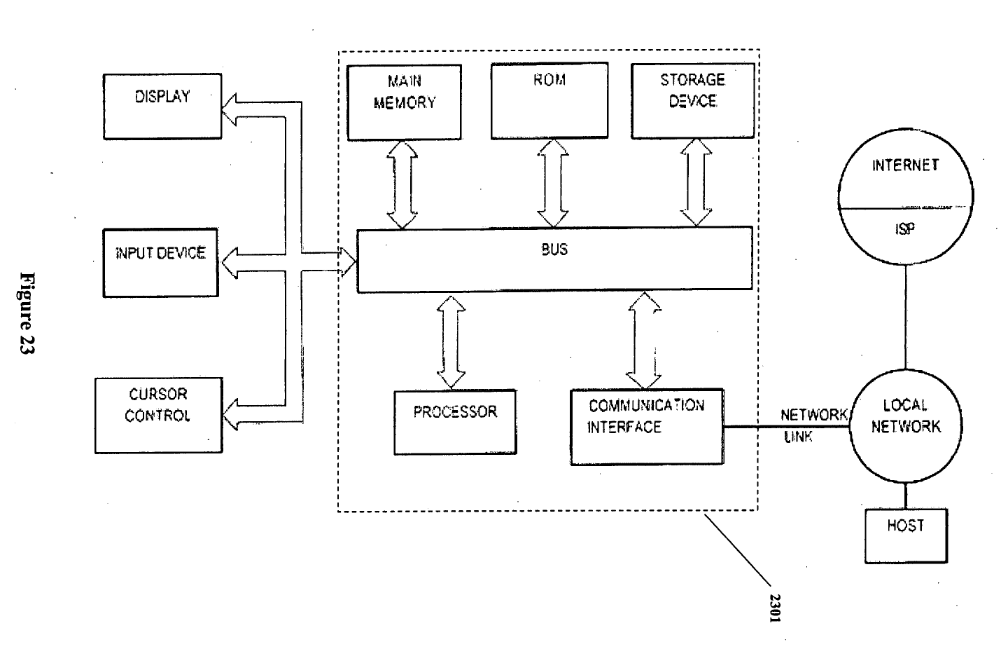

FIG. 23 is a diagram that depicts an embodiment of the approach displaying the internal components of a Web Server and its external connections. The area under the dotted line 2301 is considered sub components of the Web Server's computer. The external connections through the Communication Interface supply the necessary connections to the Internet and the Database Server.

In one embodiment of the approach the provider can suggest and display coupons to the customer based on the relevancy of the items the customer is looking for. For example, A customer enters an item through one of the previously mentioned routines (UPC, RFID, MPN, Category search, or Ad-Hoc expression), like “Quaker Granola Bars” 1306 in search of the Best Price or the closest location to purchase that item as shown in FIG. 13. The provider would return the requested information along with relevant coupons 1305 for that exact item or similar items. Similar items can be suggested based on customers inquiry patterns or by other factors such as items that have the most inquires by customers (most popular), and or item is in stock at merchants within a specified distance, and or item is the best price at merchants within a specified distance in comparison to other like items within the same specified distance, and or item is sponsored in the providers database by a merchant(s). e.g. A customer's inquiry pattern shows a list of the following items: diapers, baby bottles, baby wipes. A suggested coupon generated from the algorithm above could be “baby formula”. Coupons are supplied to the customer along with a map identifying each items location within the store that the customer ultimately chooses. Coupons are coded in a fashion suitable for the merchant to redeem the coupon in an efficient manner i.e. a UPC code or special offer code printed on the coupon. A merchant can track the success of the items listed on the provider's web site by tracking the sales volume of each item that the merchant has listed on the provider's site. In addition the merchant can calculate the total number of coupons redeemed by customers.

In one embodiment of the approach proof of purchase is received from the customer after a purchase is made for an item so that the provider can track it's success rate from it's initial search result. Customers are rewarded to give proof of purchase data back to the provider in a number of different ways. These ways are given by way of example only. A customer might receive points, addition discounts, rebates, free merchandise, or a higher ranking on the provider's web site. The proof of purchase data received from the customer can be but is not limited to, a receipt number, a serial number from the item purchased, a code on a receipt given to them by the merchant, a credit card purchase approval number, etc. The provider can assemble this data into an infinite number of reports to be given back to the merchant for there own sales analysis.

The provider will offer merchants many levels of services that they may participate in either for free or for profit. For example, a merchant can opt in for: item location inclusion, item price inclusion, item attributes inclusion, item registry inclusion etc.

In one embodiment of the approach a customer could select in their profile to include “store brands” in their search results. Store brands are items that are similar to brand name items but are labeled with a private label or a label with the store name that is selling it. Store brands are often of equal quality and sometimes are even produced by the same manufacture as the name brand counterpart. Store brands are used to increase margin to the store selling the items because they are not paying for national advertising, etc. Typically a store or chain of stores will have their own UPC prefix that they use to uniquely identify there “store branded items” If a merchant carried store brands and they wanted to associate there store brands with their like name branded items they would need to identify the items prior to or after uploading the data to the providers site. A merchant would identify each store brand item and cross reference it to a name brand item. Store brand and name brand association can be limited by the provider at the provider's discretion. For instance the provider may only allow one store brand item to be associated with one name brand item. This allowance would control the amount of relevant and irrelevant item associations that a merchant may try to cross reference in the provider's database.

In this embodiment Latitude & Longitude values can be determined by but not limited to the provider, a customer, a Merchant, a cellular service provider, a cellular device, a GPS enabled device, mapping software, an ISP (Internet Service Provider), or an ASP (Application Service Provider).

This embodiment of metric data would be but is not limited to data that is mined and sold to both merchants and manufacturers in order to assist them in better sales projections and product distribution. Mining the metric data would assist the provider in intelligent reporting. For example the provider would monitor where the customer is searching from web or wireless, which items are popular, inquires based on demographic and or geographic areas, where the merchant items are ranked in the item list as compared to other merchants.

In one embodiment of the approach the provider receives a unique item descriptor, i.e. UPC (Universal Product Code) from the customer via, but is not limited to one or more of the devices mentioned in Paragraphs 08-13. The provider then extracts the UCC (Universal Code Council) prefix from the UPC code. The UCC prefix is a combination of numbers (digits) of the 12 total numbers (digits) in the UPC. An algorithm will compute this function and return to the provider a unique identifier. The provider then references a database, it's own or a third parties, that includes a unique UCC prefixes along with other associated data The unique UCC prefixes will act as the key field to a record in the database and therefore be linked to other data that is associated with the prefix. The provider can then use the entire record in the database for additional information requirements. An example of this calculation could return manufacturer information to the customer 1204 as shown in FIG. 12.

1. A method for providing store branded item information, comprising:
identifying store branded items equivalent to brand name items;
cross-referencing said store branded items to brand name items;
storing information pertaining to store branded items and brand name items in a database;
providing selection criteria to said database, wherein said database sorts said store branded item information; and
displaying said store branded item information to a user via a communications means.
